(19) United States
(12) Patent Application Publication
(10) Pub. No.: US 2006/0117577 A1
(43) Pub. Date: Jun. 8, 2006

(54) Paint can gutter punch

(76) Inventor: Vernon C. King, (US)

Correspondence Address: Kevin Ellicott, Esq., Suite 112, 1 Scale Ave., Rutland, VT, 05701, US

(21) Appl. No.: 11/005,367

(22) Filed: Dec. 6, 2004

(51) Int. Cl. B26F 1/00

(52) U.S. Cl. 30/368

(57) ABSTRACT

A paint can lid remover and punch comprising a handle having a hollow interior, a first end and a second end, the first end having a hole with a bore communicating with the hollow interior, the second end having a hole with a threaded bore communicating with the hollow interior, a sheath, the sheath being a hollow tube having a flange, a punch having a sharpened first end and an opposite second end, an end cap having a threaded portion for engaging the elongate body second end threaded bore, the end cap threaded portion being attached to the punch second end, a spring attached to the end cap and spanning between the end cap and the sheath flange and a “j” shaped paint can lid remover attached to the elongate handle.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as painting accessories. Specifically, the instant invention is a paint can lid opener with spring loaded punch.

2. Background Information

The prior art known to the Inventor discloses that paint can lid openers are fairly well known in the art. Perhaps the simplest example of such a paint can lid opener is a flat head screwdriver. These are frequently found in the possession of tradesmen and laymen and, while not designed to be used to open a paint can lid, are most often the tool of choice for so doing. The user of the screwdriver in this fashion grasps the handle, engages the flat head of the screwdriver with the lid channel or gutter, and levers the screwdriver to pop loose the lid.

However, it has been known for some time that a screwdriver is a best an inferior solution to the problem. While the distance between the blade of the screwdriver and its handle provides additional leverage and makes it easier to “pop” the lid free from the gutter, it also tends to make the tool unwieldy and prone to slipping. Furthermore, because the user's hand is necessarily located at a fair distance from the lid during the removal process, control over the lid as it is freed from the gutter is minimal, resulting frequently in the lid literally becoming airborne and sailing across the room. Many painters both professional and non-professional have experienced the sad lesson that a paint can lid landing wet paint side down on a carpet or rug can impart.

It is also relatively well known now that when paint is poured from within the can, more often than not a certain amount of that paint will flow into and fill the gutter. The build up of paint within the gutter is frequently the cause of accidental spillage of the paint. This is most often avoided by punching holes into the gutter so that the paint which has entered the gutter may be safely and easily drain from the gutter back into the can.

In the past, gutter holes were often punched with the same screwdriver which was used to remove the lid. The blade of the screwdriver was positioned into the gutter or channel, and then a sharp blow downwardly onto the screwdriver handle was administered, driving the blade through the gutter and opening up a passage from the gutter to the interior of the can.

As many who have used a screwdriver in this manner can attest, while it is better than nothing, it is certainly not ideal. Those who have used a screwdriver as a punch have learned that the blade of the screwdriver tends to become wedged in the hole which it has just punched, forcing the user to “wiggle” the screwdriver free of the gutter hole.

It is also well known that unless the blade of the screwdriver has been driven through the gutter sufficiently, the paint will not tend to drain adequately, and the build up often results in accidentally spilled paint.

Some professional painters, having become cognizant of the detriments inherent in using a screwdriver to punch holes in the gutter, choose instead to use an awl or ice pick to punch the gutter holes. Unfortunately, both of these tools are often sharply pointed instruments, unfit for carrying in one's pocket. Therefore, in order to use an awl or pick, it is often necessary for the painter to keep the tool nearby, but not in a pocket, lest one be accidentally poked or stabbed by the tool while working.

Furthermore, because the awl or pick has no provision for stopping the tool from continuing downwardly upon the application of sufficient force to break through the gutter, the tool frequently ends up being dipped into the paint within the can. This can lead to paint dripped on the floor as the tool is removed from the can, paint on the user's hands while the tool is pulled free of the paint can, and paint on whatever surface the tool is ultimately placed.

Nowhere in the art has there been an attempt to provide for a paint can lid which is not only useful for removing the lid, but can also be used to punch paint drainage holes in a controlled manner as well as be used to firmly seat the lid back on the can afterward.

### SUMMARY OF THE INVENTION

The instant invention is a paint can gutter punch and lid opener. Unlike prior art opener/punch combination devices such as a screw driver or an awl/pick, the instant invention has the distinct advantage of punching a hole in a controlled and repeatable manner while at the same time being safer and cleaner to use.

While both the screwdriver and the pick include no mechanism for preventing the tool from punching too far through the gutter, becoming covered with paint and or becoming wedged in the hole just punched.

An object of the instant invention, therefore, is to provide for a tool which includes a means for ensuring a hole punched in a controlled and repeatable manner.

This object of the invention is accomplished by including in the instant invention a spring loaded sleeve cooperating with the handle and the punch to provide for consistency in the depth of holes punched in the gutter.

While both the screwdriver and the pick may be used to punch a hole in the gutter, neither includes any means for preventing them from punching too far into the gutter and becoming dipped in the paint within the can.

Another object of the instant invention, therefore, is to provide for a tool which will punch through the gutter without passing so deeply into the interior of the can that the punch may become covered in paint.

This object of the invention is accomplished by including in the instant invention a spring loaded sleeve cooperating with the handle and the punch to prevent the punch from extending so far into the paint can so as to be covered by paint within the can.

While an awl or pick may be used to punch a hole in the gutter, both have a sharp point at their terminating end and no means for preventing that point from stabbing into a user in the event that the user places the pick or awl in a pocket.

Another object of the instant invention, therefore, is to provide for a tool which will punch through the gutter, but includes a mechanism which can diminish the opportunity for being stabbed by the tool while the tool is within a user's pocket.

This object of the invention is accomplished by including in the instant invention a spring loaded sleeve cooperating with the handle and the punch to keep the majority of the punch shielded and thus prevent accidental stabbing to any great depth while the tool is in a user's pocket.

While an awl or pick may be used to punch a hole in the gutter, both may become covered in paint after they have punched through the gutter, and that paint may easily become transferred to a user's hand, or drip onto the surface upon which the tool is placed while not in use.

Another object of the instant invention, therefore, is to provide for a tool which will punch through the gutter, but includes a mechanism which can diminish the opportunity for paint being transferred from the punch to the user's hands or other surfaces.

This object of the invention is accomplished by including in the instant invention a spring loaded sleeve cooperating with the handle and the punch to keep the majority of the punch shielded so that even if paint has become deposited upon the punch, it may not easily be transferred to hands or other surfaces.

While the aforementioned objects of the instant invention are generally preferred, they are not exclusive. Additional thought may yield myriad other uses which, while not specifically named above, would still fall within the claims.

### A DESCRIPTION OF THE DRAWINGS

FIG. 1 is a perspective view of the first embodiment of the instant invention.

FIG. 2 is a cross sectional view of the first embodiment of the instant invention.

FIG. 3 is a close up cross sectional view of a portion of the preferred embodiment of the instant invention.

FIG. 4 is a close up perspective view of a portion of the first embodiment of the instant invention.

FIG. 5 is a perspective view of the punch in the first embodiment.

FIG. 6 is a cross sectional view of the sheath in the first embodiment.

FIG. 7 is a cross sectional view of the first embodiment at rest.

FIG. 8 is a cross sectional view of the first embodiment with the punch exposed.

FIG. 9 is a perspective view of the first embodiment in use on a paint can.

FIG. 10 is a close up portion of the first embodiment in use on a paint can.

FIG. 11 is a close up portion of the first embodiment in use on a paint can.

FIG. 12 is an elevational view of the second embodiment.

FIG. 13 is a cross sectional view of the second embodiment.

FIG. 14 is a close up perspective view of the second embodiment sheathe retainer.

### A DESCRIPTION OF THE PREFERRED EMBODIMENT

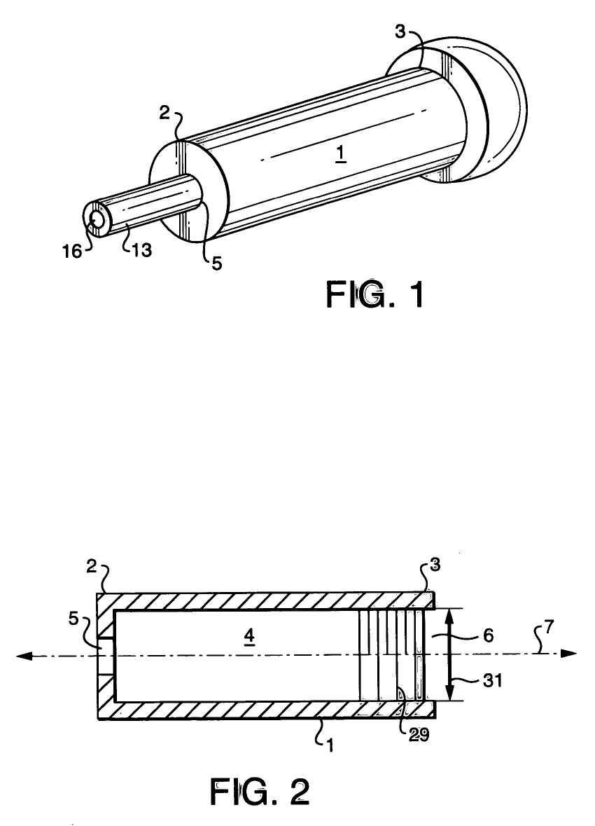

As per FIGS. 1 and 2, in the preferred embodiment, a paint can lid opener and punch includes an elongate handle (1) having a first end (2) and an opposite second end (3). Though the preferred embodiment of the handle is essentially cylindrical in shape, this is not an absolute requirement. The elongate handle is hollow, having a hollow interior space (4). The elongate handle further has a first opening (5) located on the first end (2) and communicating with the hollow interior space (4). The elongate handle further has a second opening (6) located on the second end (3) and communicating with the hollow interior space (4).

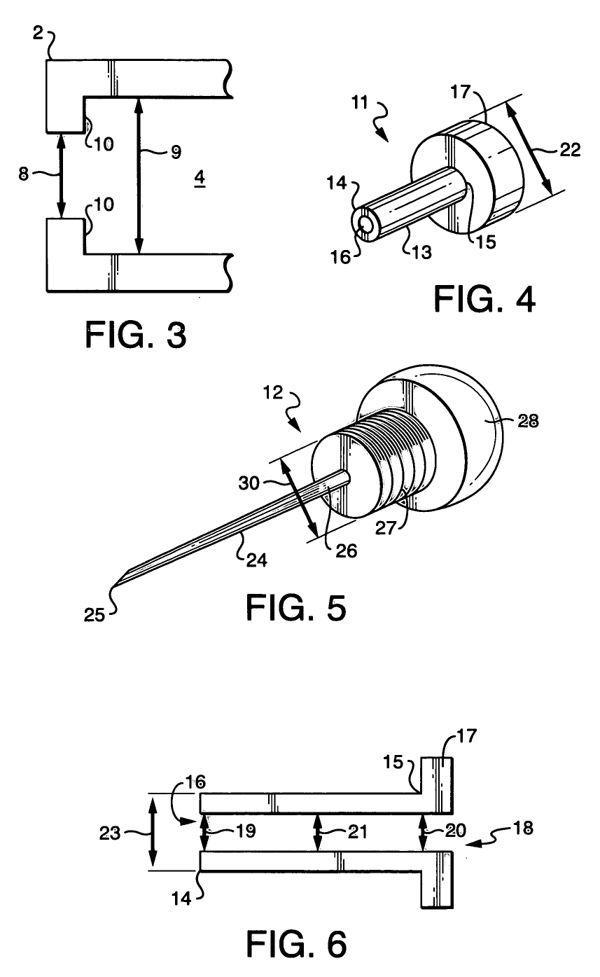

For the sake of understanding, it is useful to describe a first axis (7) as extending longitudinally through the elongate handle. In the preferred embodiment, the first opening (5) is essentially a hole having a bore passing completely through the elongate handle first end, and is co-axial with the first axis (7). As per FIGS. 2 and 3, the diameter (8) of the hole having a bore passing completely through the first end is less than the diameter (9) of the hollow interior space. Thus, a first shoulder (10) is formed, the first shoulder being radially disposed about the first opening (5), within the hollow interior space (4).

In the preferred embodiment, the second opening (6) is essentially a hole having a threaded bore (29) communicating with the hollow interior space (4), and is co-axial with the first axis (7). Therefore, the first opening, elongate handle and second opening are all essentially co-axial with one another.

As per FIGS. 1, 4 and 5, the instant invention further includes a punch sheath (11) for guiding and encasing the punch (12). The punch sheath is essentially a hollow tube or cylinder (13) having a first end (14) and an opposite second end (15). The first end (14) has a hole (16) passing completely therethrough and communicating with the interior of the hollow tube (13). The sheath further has a sheath flange (17) extending radially outwardly from and around the hollow tube, at the second end (15). The sheath flange (17) further has a sheathe flange hole (18) passing completely therethrough such that the sheath flange hole (18), the hollow tube (13) and the sheath first end hole (16) are all co-axial with one another.

In addition to being co-axial with one another, in the preferred embodiment the sheath first end hole diameter (19), the sheath flange hole diameter (20) and the sheath hollow tube diameter (21) are essentially equal to one another. Scale Ave Furthermore, as per FIGS. 3, 4 and 6, the sheath flange (17) has an outer diameter greater than the elongate handle first opening diameter (8), and nearly equal to, but somewhat less than, the elongate handle hollow interior space diameter (9). Finally, the sheath hollow tube outer diameter (23) is nearly equal to, but somewhat less than, the elongate handle first opening diameter (8) such that when fully assembled, the sheath may be inserted through the elongate handle second opening (6), into the elongate handle hollow interior space (4), and be positioned such that the sheath hollow tube (13) may be slid through and emerge out of the elongate handle first opening (5).

Obviously, because the sheath flange outer diameter (22) is greater than the elongate handle first opening diameter (8), and nearly the same as the elongate handle interior space diameter (9), it is possible for the sheath flange (17) to become seated against the elongate handle first shoulder (10), thus preventing the sheath from completely exiting the elongate handle hollow interior space through the first end of the handle. In effect, the sheath is slidably engaged within the elongate handle when fully assembled, and when so fully assembled, the elongate handle first opening (5), the sheath first end hole (16) the sheath hollow tube (13), the sheath flange (17), the sheath flange hole (20), the elongate handle hollow interior space (4), the elongate handle second opening (6) and the first axis (7) are all co-axial with one another.

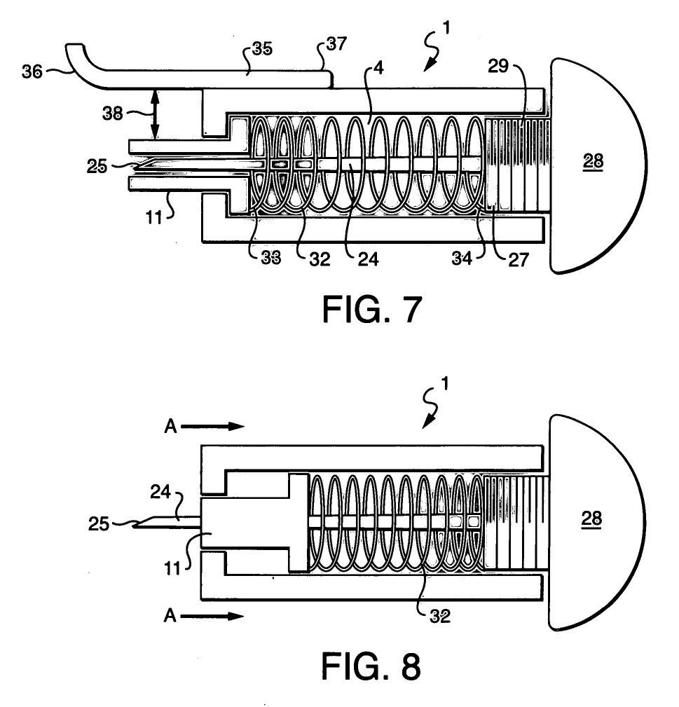

As per FIGS. 5 and 7 the instant invention further includes a punch (24) for puncturing the gutter in a paint can lid. The punch (24) is essentially an awl or needle-like body having a pointed or sharpened first end (25) and an opposite second end (26). The punch second end is firmly attached to an end cap. The end cap is composed of an externally threaded cylindrical portion (27) directly attached to the punch second end (26), and cap portion (28) attached to the externally threaded cylindrical portion (27).

The externally threaded cylindrical portion (27) of the end cap has an external diameter sized such that the threads of the externally threaded cylindrical portion may threadably engage the second opening threaded bore (29). Obviously, the threaded cylindrical portion outer diameter (30) should be nearly the same, but slightly less than the second opening threaded bore internal diameter (31) such that the externally threaded cylindrical portion of the end cap may be threadably engaged (screwed into) the second opening threaded bore when fully assembled, as per FIG. 7.

As was noted in the aforementioned objects of the instant invention, it is highly desirable to reduce the possibility that the user of the device may be stabbed or stuck by the punch (24). This object is achieved through the novel combination of the sheath (11) and a sheath biasing means (32). In the preferred embodiment, as per FIGS. 7 and 8, the sheath biasing means is a spring or helical coil having a first end (33) and an opposite second end (34). The second end is preferably attached to the end cap externally threaded cylindrical portion (27) and extends to the sheath flange (17) when the spring is in its uncompressed state. The precise method and placement of the attachment between the sheath biasing means and the end cap is unimportant so long as the attachment does not interfere with the screwing together of the end cap and the elongate handle. Where a spring is used as the sheath biasing means, and the device is fully assembled, the punch is passed axially through the spring such that the spring is essentially coiled around the punch. The spring should therefore be of sufficient dimensions such that it will fit within the elongate handle hollow interior space (4), and when not being compressed span between the externally threaded cylindrical portion (27) and the sheath flange (17) when the device is fully assembled. While a spring is chosen as the sheath biasing means in the preferred embodiment, the precise mechanisim used to bias the sheath is unimportant so long as it biases the sheath away from the end cap.

As per FIGS. 4, 7 and 8, it will now become apparent that the cooperation amongst the sheath biasing means (32), the sheath flange (17) and the punch (24) results in a paint can punch far safer and easier to use than any known to the inventor. As per FIG. 7, when the device is not being used to punch a hole in a paint can gutter, the punch pointed first end (25) is shielded by the sheath (11), and the sheath is maintained in this protective position by the sheath biasing means (32). However, when the device is in use, pressure is applied to sheath first end (14) in the direction of arrow “A”, the sheath biasing means is compressed and the sheath slides back within the elongate handle hollow interior (4) such that the punch pointed first end (25) is exposed and capable of punching a hole into the paint can gutter. When the device is pulled away from the paint can, and pressure against the sheath first end (14) is thereby removed, the sheath biasing means tends to return to its uncompressed state and the sheath is slid in the direction opposite arrow “A” so that the sheath once again shields the punch pointed first end, thus liminating the possibility of accidental stabbing or poking by an exposed sharpened punch point. Obviously, one may easily vary the materials and/or the number of coils and/or the length of the sheath biasing means to make it more or less difficult to push the sheath in the direction of arrow “A”, thereby making it easier or harder to expose the punch pointed end during use of the device. In fact, it may be desirable to provide the user of the device with a number of additional sheath biasing means so that the device may be custom configured according to the needs and physical strength of the user.

Finally, as per FIG. 7, the instant invention preferably includes a paint can lid opener (35). This may be of conventional design, and is frequently referred to as a “j” shaped body or “hook-like” body. In essence, it is an elongate body which is generally straight and has first end (36) and an opposite second end (37). Normally, the first end is somewhat curled or “j” shaped. These sorts of paint can lid openers are extremely well known in the art field, and no additional changes or modification from the norm need be made in order for it to function in association with the instant invention. The inventor simply attaches the paint can lid opener to the elongate handle (1), proximate to the elongate handle first end (2). The paint can lid opener should be attached to the elongate handle such that it spans from the paint can lid opener second end (37) towards the paint can lid opener first end (36) in the same orientation as the first axis (5) and arrow “A”.

The only additional point that should be mentioned regarding the assembly of the paint can lid opener (35) onto the elongate handle (1) is that when fully assembled together, as per FIG. 7, there should be a space (38) between the paint can lid opener (35) and the sheath (11) so that the punch may engage the paint can gutter without the paint can lid opener interfering.

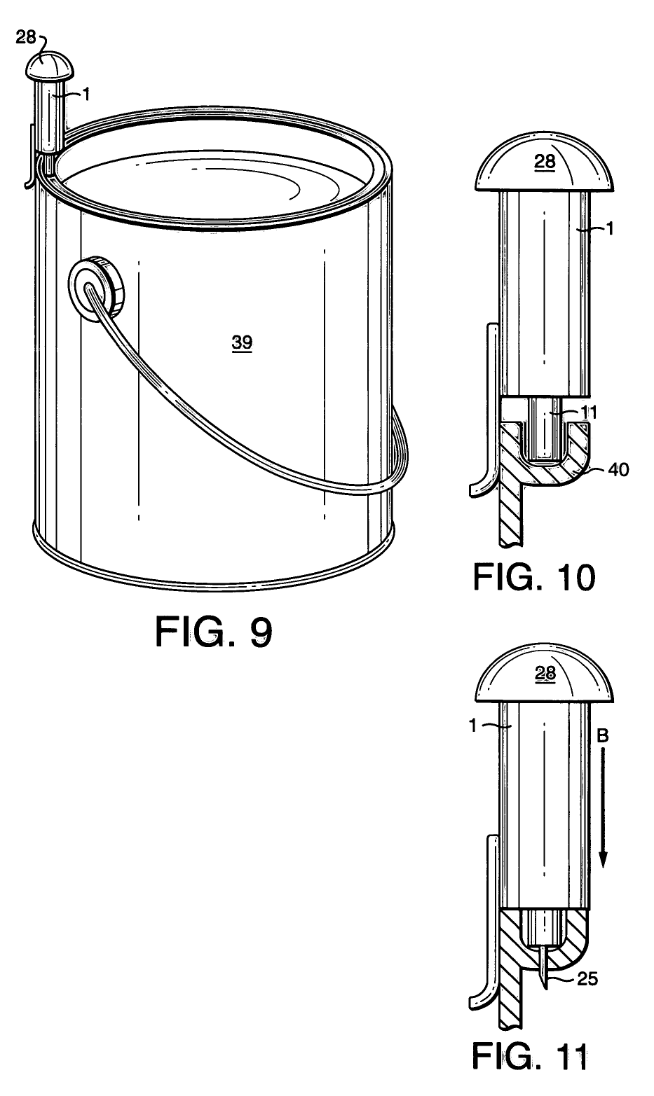

As per FIGS. 9, 10 and 11 the operation of the instant invention may now be fully appreciated. After removing the lid from a paint can (39) so that the gutter (40) is exposed and accessible, the instant invention is positioned such that the sheath first end (14) extends into the gutter. Pressure is then applied to the end cap (28) in a downward fashion relative to the paint can (in the direction of arrow “B”). The downward force brings the sheath first end into contact with the gutter (40). When there is sufficient downward pressure to overcome the biasing of the sheath biasing means, the sheath (11) slides into the elongate handle hollow interior space, exposing the punch pointed first end (25) which, under continued downward pressure will then punch a hole through the gutter, providing a passage through which paint which has become lodged within the gutter may escape back into the interior of the paint can. Having punched the hole, one merely pulls the device upwardly, opposite the direction of arrow “B” to remove the device.

It is worth noting that if a sheath biasing means is chosen which strongly biases the sheath away from the end cap (28), while the force required to expose the punch will be correspondingly greater, it has the distinct advantage of tending push the elongate handle upwardly and away from the gutter, in the direction opposite arrow “B” when the device is in use. The net effect of this is that the force of the sheath biasing means (32) will tend to push the sheath towards the gutter, thus assisting in removing the punch from the hole which it has just punched in the gutter.

Obviously, in order for the device to function as intended, the exterior diameter of the sheath should be small enough to allow its entry within the gutter. An exterior diameter of approximately 3/16 of one inch has been found sufficient.

Also, the distance between the sheath first end (14) and the sheath flange (17) should be sufficient so that the sheath will encase the punch when not in use. This distance is ideally approximately ¾ of one inch. Because the punch is firmly attached to the end cap, and because only the sheath moves when the device is in use, the length of the punch which may be exposed during use cannot be greater than the distance identified immediately above. This ensures that the punch will pass through the gutter (entering the hole the punch has just created) to a uniform distance each time. Unlike the awl or screwdriver which cannot punch a consistent hole, the instant invention will consistently punch a hole of uniform diameter, and can only push through the gutter to a uniform maximum depth each time (the maximum depth being equal to approximately the distance between the sheath first end and the sheath flange.

Finally, the space (38) between the sheath and the paint can lid opener has been found to be ideally approximately ¼ of one inch. Naturally, these are suggested dimensions and so long as the device is constructed so as to function as described herein, the particular dimensions may easily be modified without departing from the spirit and scope of the claims.

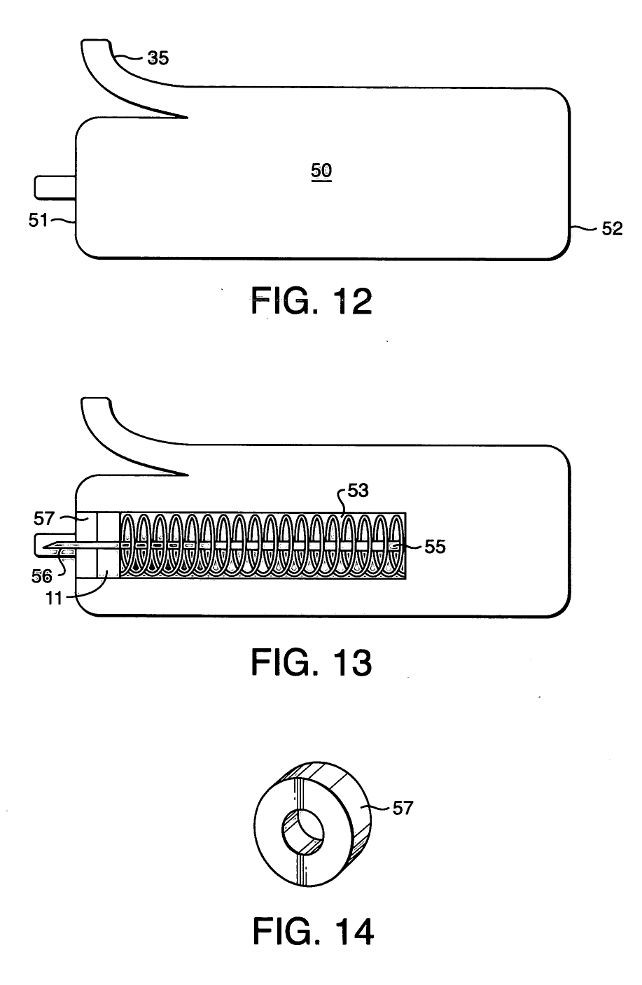

In a second embodiment of the instant invention, as per FIGS. 12 and 13, the handle (50) is in the form of a flattened rectangle having a first end (51), an opposite second end (52), a hollow interior space (53), and a second embodiment hole (54) passing through the first end and communicating with and providing access to, the interior space (53).

Like the first embodiment, the second embodiment further has a punch (55). In the second embodiment, the punch (55) having a pointed first end (56) is preferably permanently secured within the hollow interior space by welding, gluing or any other suitable means. In form, the punch (55) of the second embodiment is the same as the punch (24) of the first embodiment. So long as the punch (55) will remain fastened within the hollow interior space during use of the device, the precise means for fastening, or whether it is fastened permanently or not, will not affect the function of the invention.

Furthermore, like the first embodiment, the second embodiment includes the punch sheathe (11), having all the same attributes as described in the first embodiment, and the sheathe biasing means (32). As with the first embodiment, punch (55) is passed through the sheathe biasing means, and when the sheathe biasing means is in its uncompressed state the punch sheathe (11) shields the punch pointed first end (56).

Unlike the first embodiment of the instant invention which included the end cap (28), the hollow interior of the second embodiment can only be accessed through the second embodiment hole. Furthermore, where the first embodiment included the first shoulder (10) to retain the sheathe (11) within the hollow interior of the elongate handle, the second embodiment incorporates what is essentially a bushing as a sheathe retainer (57). As per FIG. 14, the sheathe retainer (57) is in essence a flattened washer having a hole passing therethrough (frequently referred to as a bushing) which is preferably of dimensions such that it may be press fit within the second embodiment hole, performing the same function as did the first shoulder in the first embodiment, that is, retaining the sheathe (11) within the hollow interior of the handle. Obviously, the hole passing through the sheathe retainer must be of sufficient dimensions so as to allow the hollow tube portion of the sheathe to extend through the sheathe retainer and thereby shield the pointed first end (56) of the punch.

Operation of the second embodiment is similar to the first embodiment.

The second embodiment of the invention may also include the lid opener (35), which may be attached to the second embodiment after the handle is manufactured, or may be manufactured integrally with the handle.

I claim:

1. A paint can gutter punch comprising:
A. a handle having a hollow interior space and a hole with a bore communicating with said interior space,
B. a sheath,
I. the sheathe being slidably mounted within the hole bore,
C. a punch,
I. the punch being located within the handle hollow interior space and extending outward, through the hole with a bore,
D. a sheath biasing means
I. the sheath biasing means being located within the handle hollow interior space and cooperating with the sheath to bias the sheath so that the sheath encases the portion of the punch which extends out through the hole with a bore.

2. A paint can gutter punch according to claim 1, further comprising:
A. The punch having a first end and a second end, the first end being sharpened, the second end being fixedly attached to the handle.

3. A paint can gutter punch according to claim 1, further comprising:
A. The sheath biasing means being a helical coil.

4. A paint can gutter punch according to claim 1, further comprising:
A. a “j” shaped paint can lid remover being attached to the elongate handle.

5. A paint can gutter punch according to claim 2, further comprising:
A. a “j” shaped paint can lid remover being attached to the elongate handle.

6. A paint can gutter punch according to claim 3, further comprising:
A. a “j” shaped paint can lid remover being attached to the elongate handle.

7. A paint can gutter punch comprising:
A. an elongate handle having a hollow interior space,
I. the elongate handle having a first end,
a. the first end having a hole with a bore communicating with the hollow interior space,
II. the elongate handle having a second end
a. the second end being opposite the first end,
b. the second end having a hole with a threaded bore communicating with the hollow interior space;
B. a sheath,
I. the sheath being a hollow tube,
II. the sheath having a flange,
III. the sheath being slidably engaged with the hollow handle first hole having a bore, within the elongate handle hollow interior space;
C. a punch,
I. the punch having a sharpened first end and an opposite second end,
D. an end cap,
I. the end cap having an externally threaded portion for threadably engaging the hollow handle second end hole having the threaded bore,
a. the externally threaded portion further being attached to the punch second end,
E. a sheath biasing means,
I. the sheath biasing means being located within the elongate handle hollow interior space,
II. the sheath biasing means being attached to the end cap externally threaded portion and extending to the sheath flange,
F. a “j” shaped paint can lid remover being attached to the elongate handle.

8. A paint can gutter punch comprising
A. a handle having a hollow interior space, and a hole with a bore communicating with said interior space,
B. a sheath,
I. the sheathe being slidably mounted within the hole bore,
C. a punch,
I. the punch being located within the handle hollow interior space and extending outward, through the hole with a bore,
D. a sheath biasing means,
I. the sheath biasing means being located within the handle hollow interior space and cooperating with the sheath to bias the sheath so that the sheath encases the portion of the punch which extends out through the hole with a bore,
E. a sheath retainer mounted within the handle hole for retaining the sheath and preventing it from falling completely out of the hollow interior.

9. A paint can gutter punch according to claim 8, further comprising:
A. The punch having a first end and a second end, the first end being sharpened, the second end being fixedly attached to the handle.

10. A paint can gutter punch according to claim 8, further comprising:
A. The sheath biasing means being a helical coil.

11. A paint can gutter punch according to claim 8, further comprising:
A. a “j” shaped paint can lid remover being attached to the handle.

12. A paint can gutter punch according to claim 9, further comprising:
A. a “j” shaped paint can lid remover being attached to the handle.

13. A paint can gutter punch according to claim 10, further comprising:
A. a “j” shaped paint can lid remover being attached to the handle.
